(19) United States
(12) Patent Application Publication
(10) Pub. No.: US 2010/0019985 A1
(43) Pub. Date: Jan. 28, 2010

(54) Header with integral antenna for implantable medical devices

(76) Inventors: Jacob Bashyam, Santa Clara, CA (US); James Long, Sunnyvale, CA (US); Steven R. Johnson, Fair Haven, NJ (US)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,566

(22) Filed: Jul. 24, 2008

(51) Int. Cl. H01Q 1/40

(52) U.S. Cl. 343/873

(57) ABSTRACT

Antenna assemblies for an implantable medical device are disclosed. The implantable medical device comprises a hermetically sealed housing, typically formed of titanium materials, and electronics, including a transceiver, disposed therein. An antenna is disposed in an air, gas or plastic dielectric filled compartment within a header, which is attached to the housing. The header is premolded so as to create the compartment. The antenna is then placed within the compartment, which is then sealed.

### FIELD OF USE

This invention is in the field of implantable devices. More particularly, the invention relates to antenna designs for implantable medical devices.

### BACKGROUND OF THE INVENTION

The medical implant communications service (MICS) Radio-Frequency (RF) band for implantable devices is a wireless telecommunications standard that describes communication in a frequency band between 402 MHz and 405 MHz. An implanted device operating according to this standard should be able to send/receive data to/from external devices that are at least 2 meters away from the implant. The maximum allowed power on the body surface from RF emanating from the implanted device is 25 micro-Watts.

The free-space wavelength of RF at 403 MHz is 74.4 cm. However, because the human body is a lossy multi-layered dielectric media, optimum antenna length in a human body is much smaller than antenna length in free space. The presence of the human body complicates antenna design, especially in light of the relatively high frequency band associated with MICS and the difficulties associated with integrating an antenna with a biocompatible implantable device.

There are a number of designs involving wire antennae disposed on the outside of an implantable device. For example, U.S. Pat. No. 7,047,076 B1 discloses a non-planar, inverted-F antenna disposed on a perimeter side of the housing adjacent to a device header. The antenna is coupled to a transceiver within the housing through a feed-through. The antenna includes a shunt arm that is electrically coupled to the header. Similarly, U.S. Pat. No. 6,809,701 B2 discloses an antenna that extends from a device header and wraps circumferentially around the perimeter of the housing. U.S. patent publication numbers 2002/0123776 and 2005/0134521 A1 disclose antennae disposed within the header of an implantable device. U.S. Pat. No. 7,016,733 discloses two antennae “elements”, each disposed in a separate header; the two headers together form an “L” shape that fits to the perimeter of an implantable device housing.

Despite all of the above work, there is still a need for an efficient or compact antenna design for an implantable medical device.

### SUMMARY OF THE INVENTION

These and other objects and advantages of this invention will become obvious to a person of ordinary skill in this art upon reading of the detailed description of this invention including the associated drawings as presented herein.

The present invention pertains to an implanted medical device that is part of a system that includes external equipment, such as a programmer, that wirelessly communicates with the implanted device. The device comprises a hermetically sealed housing, typically formed of titanium alloy that contains electronic components, including a transceiver. The housing has an angled upper edge which mates with a plastic header that has a lower angled edge to conform to the upper edge of the housing. The header comprises an antenna that is electrically coupled to the transceiver via wires and a feed-through that passes through the housing. The antenna, preferably a helix, is disposed in a compartment within the header that is preferably filled with a material characterized by a low dielectric constant.

A preferred manufacturing process is also described according to which a header is pre-molded with a compartment (e.g. the above mentioned bore) for receiving an antenna. An antenna is then disposed within the compartment and the resulting assembly is then attached to the device housing so that a wire runs through a feed-through in the housing and through a channel in the header. The wire is electrically connected to the antenna. The antenna compartment is then backfilled with silicone and then sealed with a cover. By utilizing this process, an antenna can be assembled after the header is molded, offering the flexibility to change the antenna to any length and any material, and eliminates an expensive insert-molding process. Also, this process allows the antenna to have a wide variety of shapes.

### BRIEF DESCRIPTION OF THE DRAWINGS

FIG. 1 illustrates an example of a system in which the present invention may be useful. The system comprises an implantable medical device that includes an antenna that is the subject of the present invention. The implantable device may engage in two way communication with an external device that is meters away from the implantable device.

FIG. 2 shows the implanted medical device of FIG. 1 in more detail. The device comprises a main body attached to a header, which has an antenna disposed within a compartment within the header.

FIGS. 3 and 4 are overhead and cross sectional views; respectively, of the preferred embodiment of the header assembly of FIG. 2.

FIG. 5a illustrates a cross sectional top view of an alternate embodiment of an implantable medical device with an antenna assembly disposed on a perimeter side surface of the implantable device's housing. FIGS. 5b and 5c are cross-sectional views taken along different lines shown in FIG. 2a.

FIGS. 6a and 6b are expanded top and side cross sectional views, respectively, of the antenna assembly shown in FIGS. 5a, 5b and 5c.

FIG. 7 shows an antenna that comprises a dipole z-shaped micro-strip antenna etched on a substrate.

FIG. 8 shows an embodiment wherein an antenna comprises a monopole inverted-F type z-shaped micro-strip antenna disposed on a substrate.

FIG. 9a shows a monopole micro-strip serpentine antenna with only the signal feed at one end. This can be converted to an inverted-F serpentine antenna by adding a ground feed (connected to the housing) and moving the signal feed to some distance from the ground feed as shown in FIG. 9b.

FIG. 10 shows an inverted-F monopole micro-strip spiral antenna.

FIG. 11 shows an embodiment wherein an antenna comprises an inverted-F monopole vertical Z type wafer antenna standing (on the Z side or the wafer edge) on a substrate.

FIG. 12 similarly shows an inverted-F monopole vertical serpentine wafer antenna standing on a substrate.

FIG. 13 shows a monopole helical wire antenna without the ground feed, where its one end is connected to the signal feed.

FIG. 14 shows a monopole vertical meandering wafer antenna whose one end is connected to the signal feed.

FIG. 15 shows a monopole vertical spiral wafer antenna, standing on the wafer edge.

FIG. 16 shows a slanted dipole antenna, where each antenna half is positioned at 45 degrees to the perimeter surface of the housing.

FIG. 17 illustrates an alternative embodiment with antenna configurations as before, but with an asymmetrical header profile configuration.

FIG. 18 illustrates an alternative embodiment according to which an antenna assembly is disposed on an extended or protruding broad surface of the implantable device's metal housing. The antenna is insulated from the housing surface by an insulating substrate material, and both antenna and the extended broad surface are molded in an insulating superstrate material to insulate the antenna from the body fluid and tissue. The implantable device's header configuration has an asymmetrical profile.

FIG. 19 shows an embodiment in which a single insulating layer is molded over the antenna to insulate the antenna from the perimeter side of the housing as well as from the body fluids and tissue. An air gap surrounds the antenna.

FIG. 20 is a flowchart pertaining to the preferred manufacturing process for assembling the implantable device with header shown in FIG. 2-4.

FIG. 21 is an alternate embodiment of a header assembly that includes an antenna disposed within a header compartment. Air fills the space between the antenna the boundaries of the compartment.

### DETAILED DESCRIPTION OF THE INVENTION

Various references will be made to cuboid components (e.g. a substrate) defined by a length, depth and height, having two major parallel surfaces (length×depth surfaces) that generally have a much greater surface area than the other four surfaces. For convenience, when referring to the orientation of the cuboid with respect to another surface, the cuboid will be treated as a surface, not a volume, defined by either of the two major parallel surfaces. Thus, for example, if a substrate is said to be mounted parallel to a container's surface, then either of the cuboid's two major surfaces are mounted parallel to the container's surface.

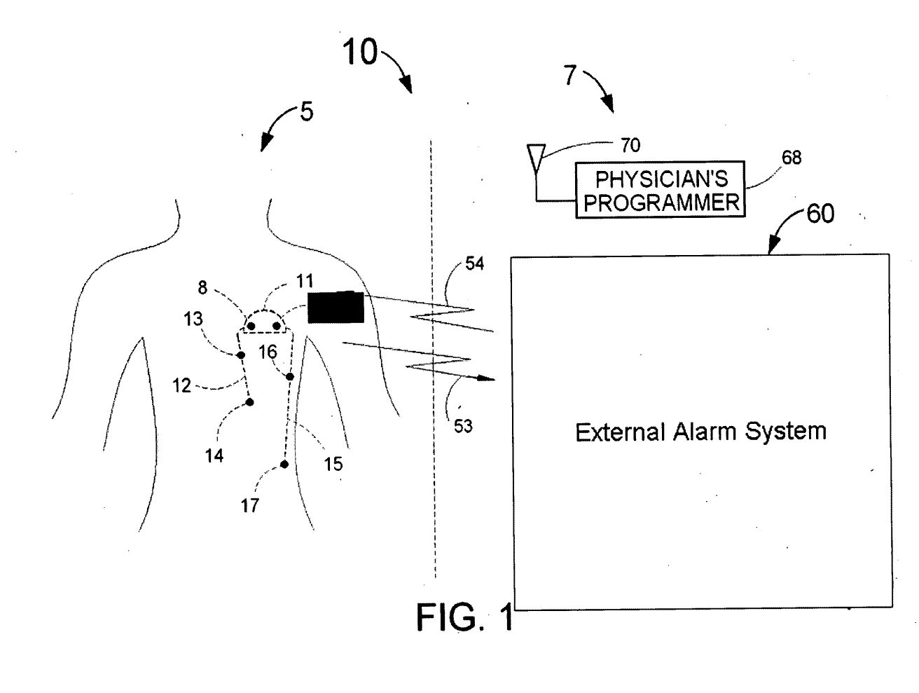

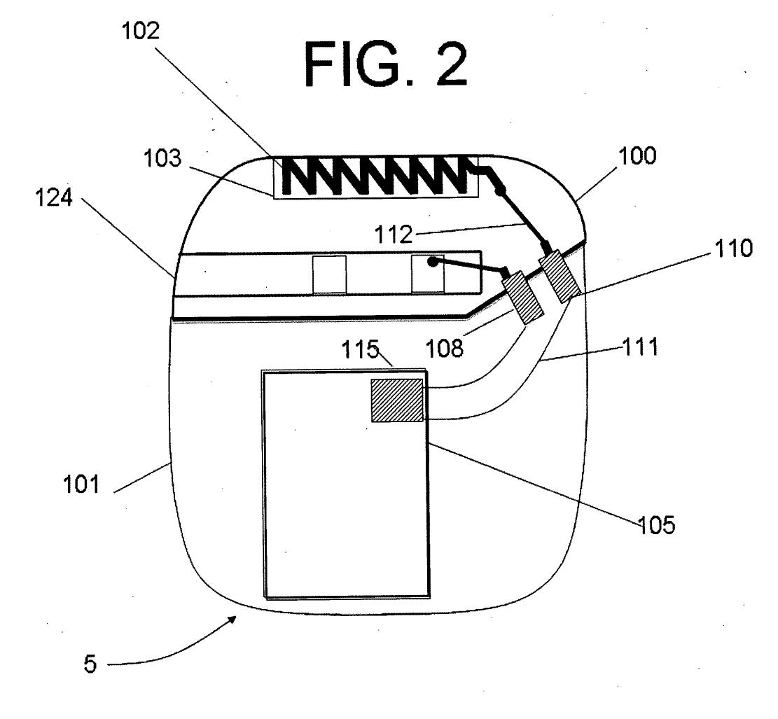

FIG. 1 illustrates one embodiment of a system 10 consisting of a patient side system 5 and external equipment 7. The patient side system includes an implanted medical device 11 that comprises a housing 101 (FIG. 2) that contains a transceiver (not shown) and electronic circuitry that can detect a cardiac event such as an acute myocardial infarction or arrhythmia and warn the patient when the event occurs. The medical device 5 can store the patient's electrogram for later readout and can send wireless signals 53 to and receive wireless signals 54 from the external equipment 7. It will be appreciated that the medical device 5 could be implanted in other places and serve other diagnostic and/or therapeutic functions (e.g. brain stimulation).

The medical device 5 has two leads 12 and 15 that have multi-wire electrical conductors with surrounding insulation. The lead 12 is shown with two electrodes 13 and 14, commonly referred to as RING and TIP electrodes, respectively. The lead 15 has subcutaneous electrodes 16 and 17. An electrode 8 is placed on the outer surface of the housing 200. In another embodiment, both leads 12 and 15 can be subcutaneous.

FIG. 1 also shows the external equipment 7 that consists of a physician's programmer 68 having an antenna 70, an external alarm system 60. The external equipment 7 provides means to interact with the medical device 5. These interactions include programming the medical device 5, retrieving data collected by the medical device 5 and handling alarms generated by the medical device 5.

Various other modifications, adaptations, and alternative designs are of course possible in light of the above teachings. Therefore, it should be understood at this time that, within the scope of the appended claims, the invention can be practiced otherwise than as specifically described herein.

FIG. 2 shows the implanted medical device 5 in more detail. The device 5 comprises a hermetically sealed housing 101, typically formed of titanium alloy that contains electronic components 105, including a transceiver 115. The housing 101 has an angled upper edge which mates with a plastic pre-molded header 100 that has a lower angled edge to conform to the upper edge of the housing 101. The header 100 comprises a helical antenna 102 that is electrically coupled to the transceiver 115 via a wire 112, a feed-through 110, and a wire 111. The feed-through 110 passes through the housing 101 and is connected on its ends to the wires 112 and 111, respectively, which are in turn connected to the antenna 102 and transceiver 115, respectively.

The antenna 102 is disposed within a compartment 103 in the header 100. The preferred configuration of the antenna 102 will be described in more detail below.

The header 100 includes a lead bore 124 that receives an electrical lead (e.g. lead 12 in FIG. 1) that is electrically coupled to the electronics components through wires 114 and 113 that are connected to opposing ends of a feed-through 108. The feed-through 108 preferably includes a filter while the feed-through 110 preferably does not have a filter.

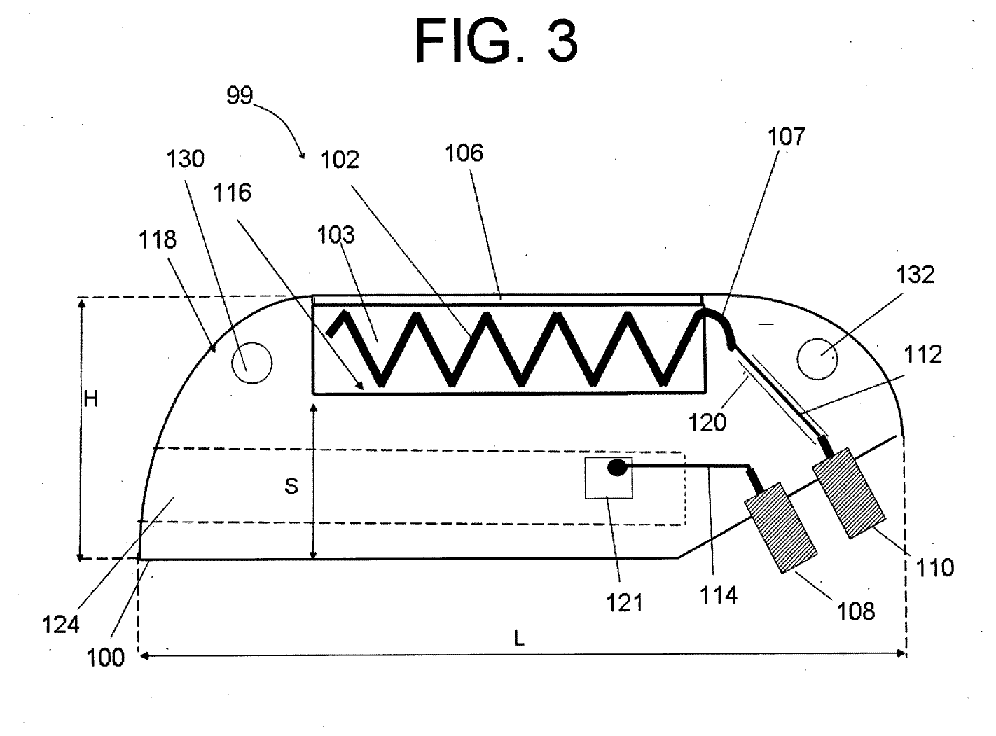

FIG. 3 is an overhead view of the preferred embodiment of a header assembly. A header assembly 99 comprises a header 100 that includes the antenna 102 disposed within the compartment 103. A first end of the antenna 102 is electrically coupled to the feed-through 110 through an antenna wire 112 disposed within a cavity 120 formed in the header 100. A preformed tail 107 of the antenna 102 is welded to a platinum antenna wire 112. A cap 106 defines the outer boundary of the compartment 103.

The header 100 and cap 106 are preferably formed of Tecothane® TT1075D-M (Lubrizol Advanced Materials, Inc.). The compartment 103 that contains the antenna 102 is preferably filled with a medical adhesive, Nusil Med 4765, 35 durameter, platinum cured medical grade Silicone, or another type of low viscosity Silicone. It is important that air bubbles in the filling are eliminated, so the dielectric filling is uniform.

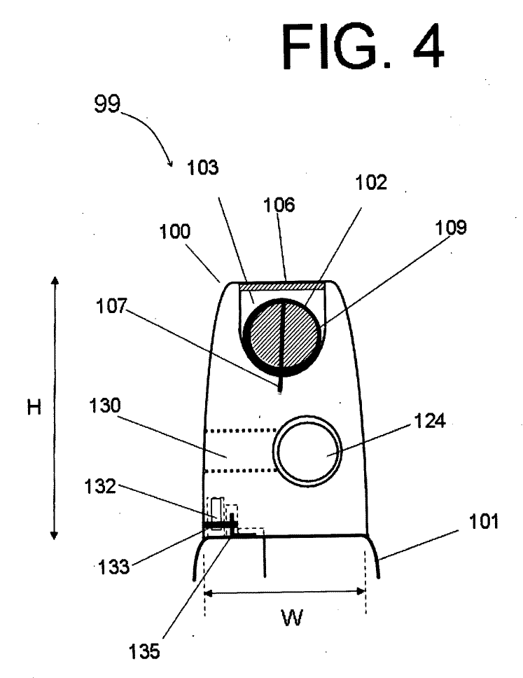

The antenna 102 preferably comprises a helically wound coil made of 99.99% pure solid silver round wire of gage #22 (0.025″ or 0.64 mm dia.), wound over either an air core (by means of a withdrawable cylindrical rod) or a Tecothane cylindrical rod 109 (see FIG. 4). The uncoiled or linear length of the antenna 102 is 90 mm, which is equal to ⅛ of the MICS wavelength in free space or ¼ of MICS wavelength in human body. The diameter of the wire is 0.64 mm (25 mil), AWG #22. The inner diameter of the antenna 102 is 3.8 mm. The spacing between coil turns is 3.2 mm. The outer diameter of the antenna 102 is 5.5 mm max. The antenna 102 comprises 5+ equally spaced turns, which results in a 18 mm length as measured between the ends of the wound antenna 102. The preformed tail 107 is preferably 6-8 mm long.

The lead bore 124 receives an IS-1 lead assembly comprising TIP block contact 121. The contact 121 is electrically coupled to the feed-through 108 by a platinum wire 114 disposed within a cavity in the header 100. The platinum wire 114 is welded to the TIP block contact 121. Suture holes 130 and 132 (0.08″ diameter) are provided so that the implantable device can be anchored to a fixed location in the human body during the implant to prevent the device migration with time.

FIG. 4 is a cross sectional view of the header assembly 99 that helps to show the geometrical relationship between the antenna compartment 103 the antenna 102, and the core 109. The compartment 103 is U shaped. The antenna 102 rests upon the bottom of the U. Also shown is a set screw 130 and an ID tag 132. An L bracket 135 is mounted upon the housing 101. A stainless steel pin 133 anchors the header 100 to the L bracket 135. The preferred header height (H) and width (W) are 14.25 mm and 10.1 mm, respectively.

The bottom of the U-shaped compartment 103 is at least 7 mm from the bottom of the header 100. The separation between the outer edge of the antenna 102 and any outside surface of the header 100 and cover plate 106 is no less than 1 mm (0.04″).

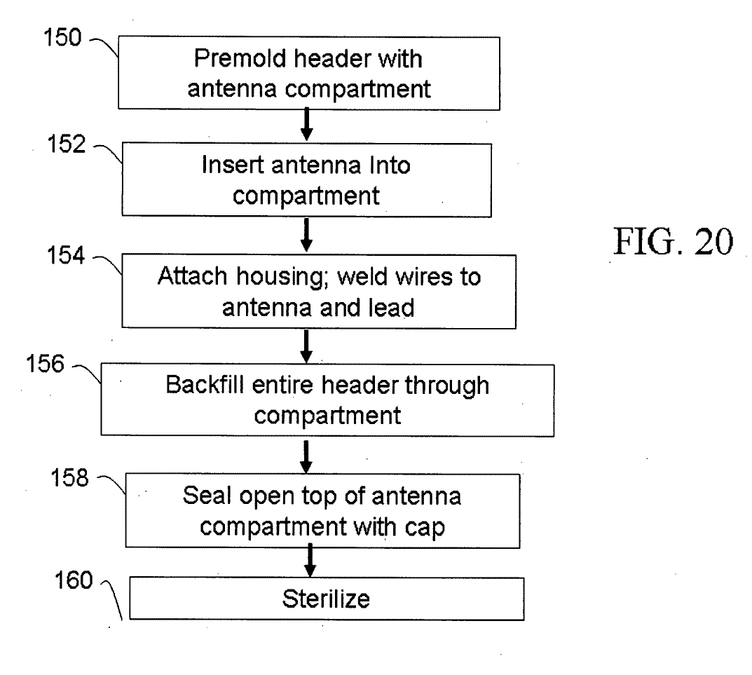

The preferred manufacturing process for the header assembly 99 will now be described with reference to FIG. 20. In step 150, the header 100 is pre-molded in Tecothane® polymer which has a dielectric constant of approximately 4.5. The mold is configured so that the header 100 is formed with the compartment 103 for receiving the antenna 102. Also, the mold is shaped so that windows are formed over the areas where the antenna 102 is welded to the wire 112 (see FIG. 3) and where the wire 114 is welded to TIP block contact 121. The mold has interior structures that result in the cavities (e.g. cavity 120 in FIG. 3) through which all wires (e.g. wires 112 and 114) may pass through, including a cavity that receives the tail 107 of the antenna 102

In step 152, the antenna 102 is placed into the compartment 103 so that the tail 107 extends through the compartment and to the weld window through which it will be welded to wire 112. In step 154, the housing 101 is firmly attached to the header 100, such that wires 114 and 112 are disposed in their respective cavities (e.g. cavity 120 for wire 112), with their free ends appear under the weld windows. The antenna tail 107 is then welded to wire 112. The lead wire is welded to TIP block contact 121.

In step 156, the silicone backfill (Nusil Med 4765, 35 durameter, platinum cured medical grade Silicone) is then manually injected carefully (avoiding any air bubbles) into the compartment 103 and the header cavities so that the entire header is filled and sealed. In step 158, the cap 106 is attached to the top of the compartment 103. In step 160, the assembly is annealed at 60°+/−5° C. for 4-6 hours.

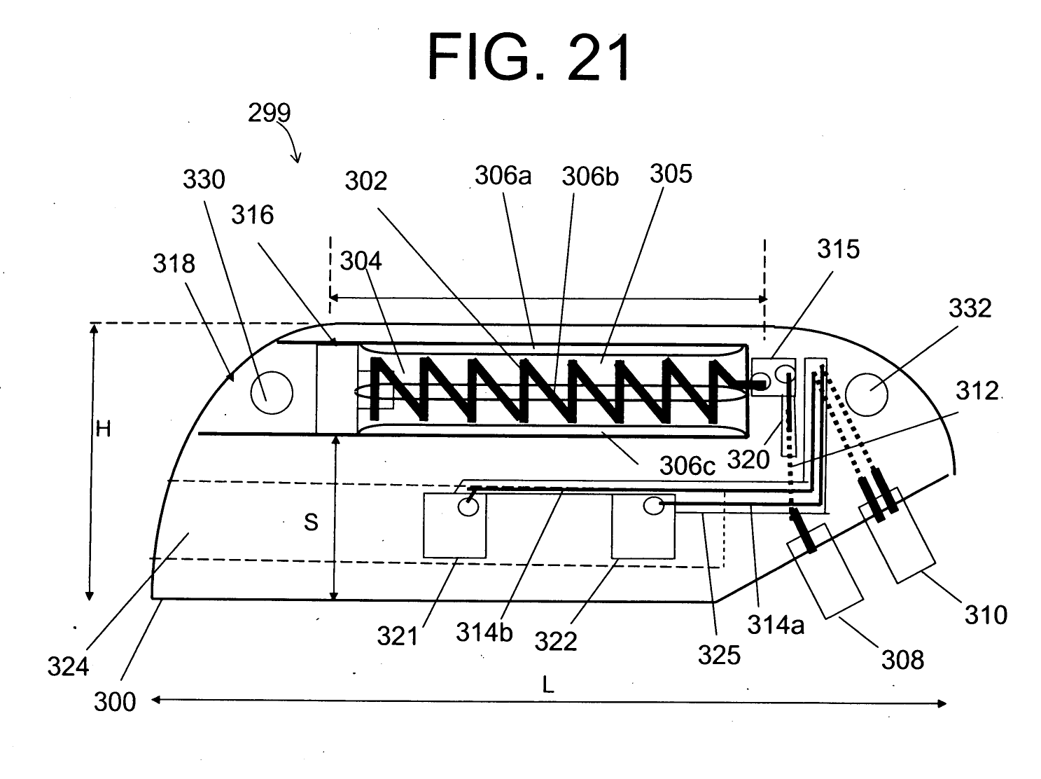

FIG. 21 is an overhead view of an alternate embodiment of a header assembly with an antenna compartment in the header. A header assembly 299 comprises a header 300 that includes an antenna 302 disposed within an antenna bore 304 having integral ribs 306a, 306b and two others (not shown) formed therein. The antenna bore 304 is a specific implementation of the compartment 103 shown in FIG. 2. A first end of the antenna 302 is electrically coupled to a feed-through 308 through a steel plate 315 and an antenna wire 312 disposed within a channel 320. The antenna 302 and antenna wire 312 are welded to the steel plate 315, which therefore serves to electrically couple the two.

A second end of the antenna 302 is wrapped around an annular portion of a plug 316, which is tightly fit within the antenna bore 304, thereby serving to keep the antenna 302 in place. Silicon backfill 318 fills the antenna bore 304 from the plug 316 to the edge of the header 300 so that the edge of the header 300 forms a smooth arc in the area around the antenna bore 304. The result of the antenna configuration shown in FIG. 21 is that the antenna 302 is surrounded by air.

The lead bore 324 receives an IS-1 lead assembly comprising RING and TIP contacts 321 and 322 respectively. The TIP contact 322 is electrically coupled to a feed-through 310 by a wire 314a disposed within a channel 325. The RING contact 321 is electrically coupled to the feed-through 310 by a wire 314b disposed within the same channel 325 or a different channel. Suture holes 330 and 332 (0.08″ diameter) are provided to the sides of the antenna bore 304, so that the implantable device can be anchored to a fixed location in the human body during the implant to prevent the device migration with time.

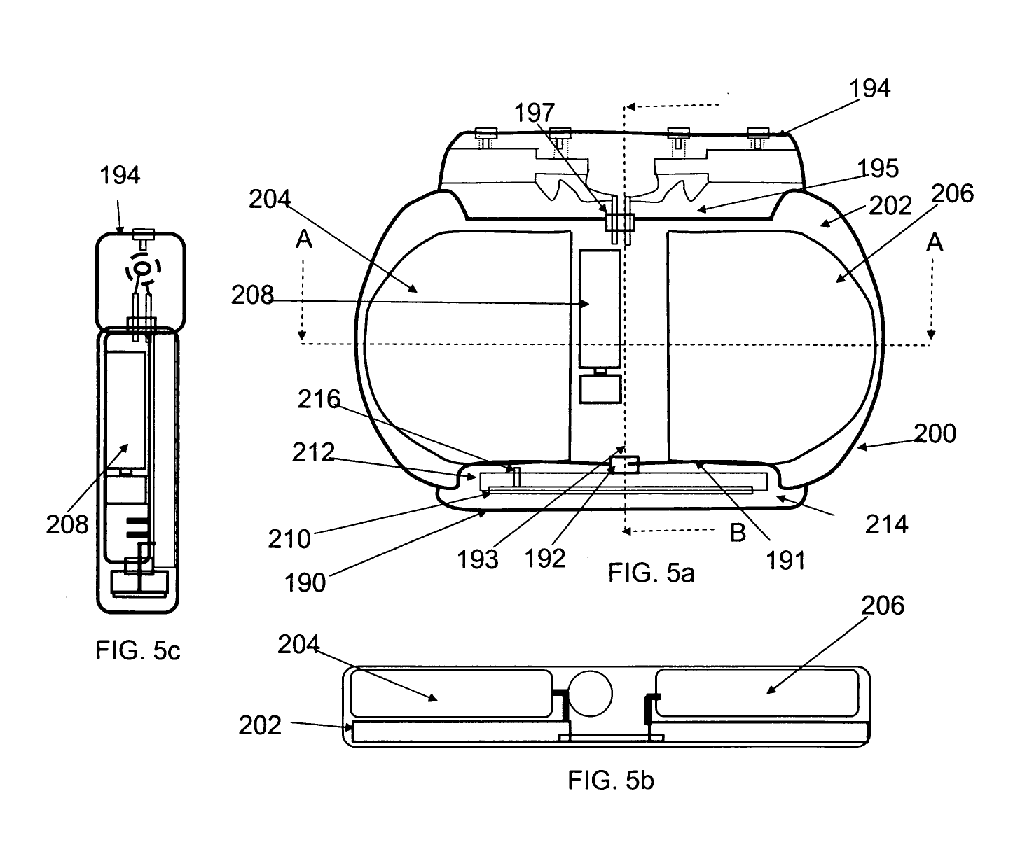

FIG. 5a illustrates a cross sectional top or broad-side view of one embodiment of medical device 5 with an antenna assembly (footer) 190 disposed according to the teachings of a different embodiment of the present invention. The medical device 5 comprises a hermetically sealed housing 200, typically formed of titanium alloy, that contains a printed circuit board (PCB) 202, batteries 204 and 206, and a vibration motor 208. The housing 200 comprises front and rear broad surfaces 218 and 220 (FIG. 5c) and perimeter side surfaces 191 and 195 such that the housing has a part rectangular, part curvilinear outline.

The footer 190 is disposed on an outer perimeter surface 191 of the housing 200, which has an indentation in the housing 200 for receiving the footer 190. The footer 190 is coupled to the transceiver (not shown) by a wire or pin 193 that passes through a main feed-through 192. A ground feed through 216 couples the antenna 210 to the housing 200, which serves as a ground reference.

A header assembly 194 is disposed on an outer perimeter surface 195 opposite the outer perimeter surface 191. The header assembly contains wires that couple external electrodes (see FIG. 1) to the electronic components within the housing 200 through a feed-through 197.

The PCB 202 contains the transceiver 9, a microprocessor and other electronics (not shown) that control the operations of the medical device 5. The batteries 204 and 206 supply power both to these electronic components and the motor 208, which vibrates to inform the patient that some relevant event is occurring, as is disclosed in U.S. Pat. No. 7,107,096 to Fischell et al. and related patents.

The footer 190 comprises an antenna 210 disposed on a substrate 212. The antenna 210 and substrate 212 are embedded within a superstrate (overmold) 214. The footer 190 is mounted such that the substrate 212 is substantially parallel to the perimeter side 191. The substrate 212 preferably comprises Macor, ceramic alumina, Teflon, parylene or PTFE. The superstrate 214 preferably comprises a low electrical loss material such as bionate, tecothane, implant grade epoxy, or silicone. The antenna 210 preferably comprises platinum-iridium (90%/10% ratio), platinum, gold, silver, or alloys of the foregoing. In embodiments wherein the antenna 210 is a micro-strip antenna, its thickness is a few mils. In certain embodiments, the antenna 210 may also comprise wire or foil laid flat and glued over the substrate.

FIGS. 5B and 5C show cross sectional views taken along lines A and B, respectively, in FIG. 2A.

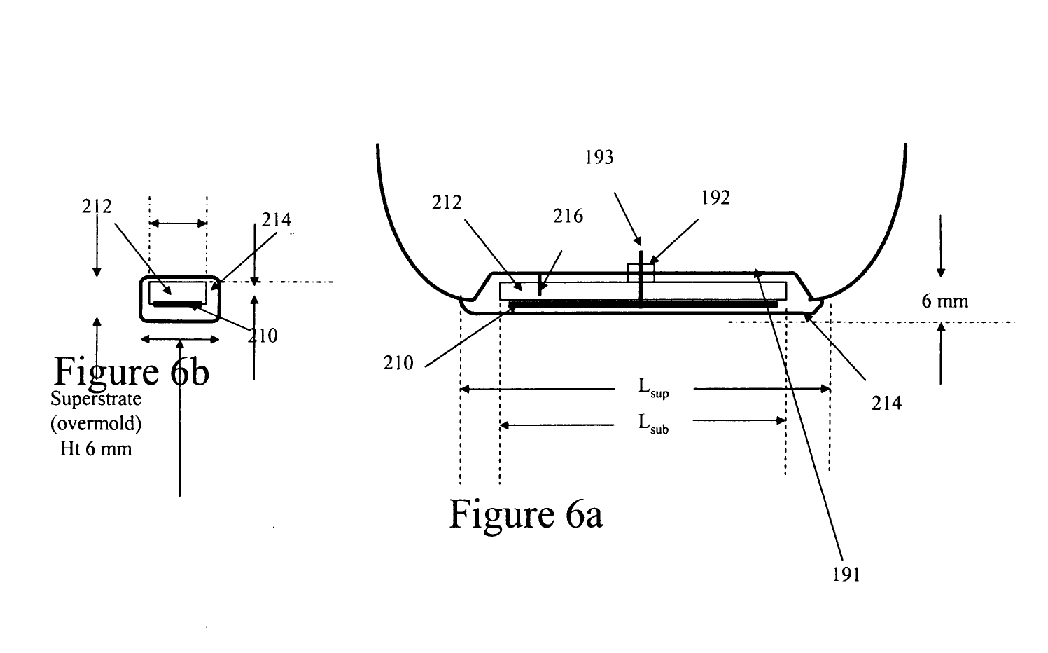

FIGS. 6a and 6b are the expanded top and side cross sectional views, respectively, of the footer 190 (FIG. 2). Preferred lengths (horizontal dimension in FIG. 3a) L_{sub} and Lₛᵤₚ of the substrate 212 and superstrate 214 are 30-35 mm and 40-45 mm, respectively. Preferred thicknesses (vertical dimension in FIG. 6b) of the substrate 212 and superstrate 214 are 2.5 mm-3 mm and 6 mm-8 mm, respectively. The preferred widths (horizontal dimension in FIG. 6b) of the substrate 212 and superstrate 214 are 7 mm and somewhat less than 9 mm, respectively.

The footer 190 may be assembled and attached to the device 5 in the following manner. First, the antenna 210 is etched into or laid flat (if a wire or foil) on the substrate 212, with two micro sockets in the substrate 212 soldered to the antenna 210, for mating with the wires/pins 193 and 216. The combination of the antenna 210 and substrate 212 is then molded within the superstrate 214 to form a separate antenna footer which then can be attached to the antenna wires/pins 193 and 216 through the micro sockets. Alternatively, the pcb antenna 210 can be laid flat over the substrate 212, connections made to the wires/pins 193 and 216, and implant grade epoxy material can then be poured over it in a mold to form an integrated antenna footer. (In this case, the epoxy serves as the superstrate 214.)

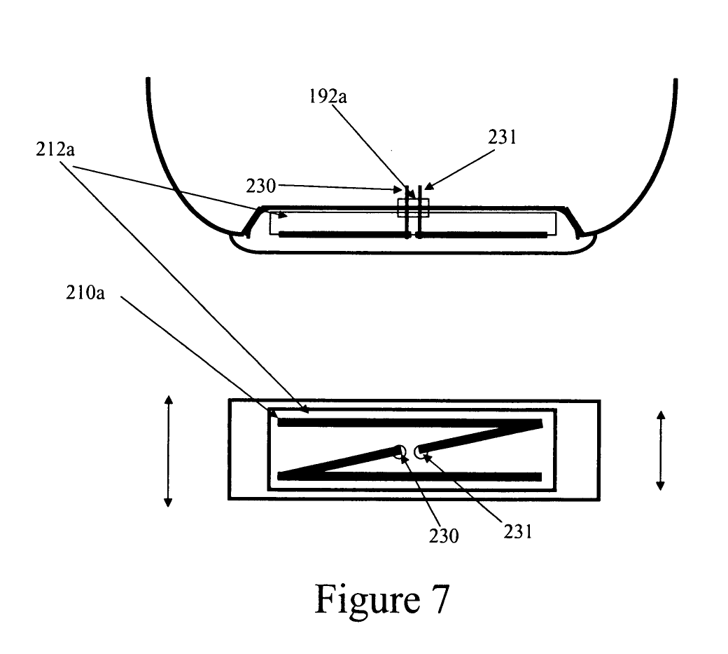

FIG. 7 shows an embodiment wherein an antenna 210a comprises a microstrip dipole z-shaped antenna disposed on a substrate 212a. In this case, a feed-through 192a has two wires/pins 230 and 231 that attach to the first and second poles respectively, of the dipole antenna 210a. Each of the two sections of the dipole antenna 210 has a length of approximately 4.6 cm (or approximately 1/16^{th} of free-space wavelength of 74.4 cms at MICS band of 402-405 MHz).

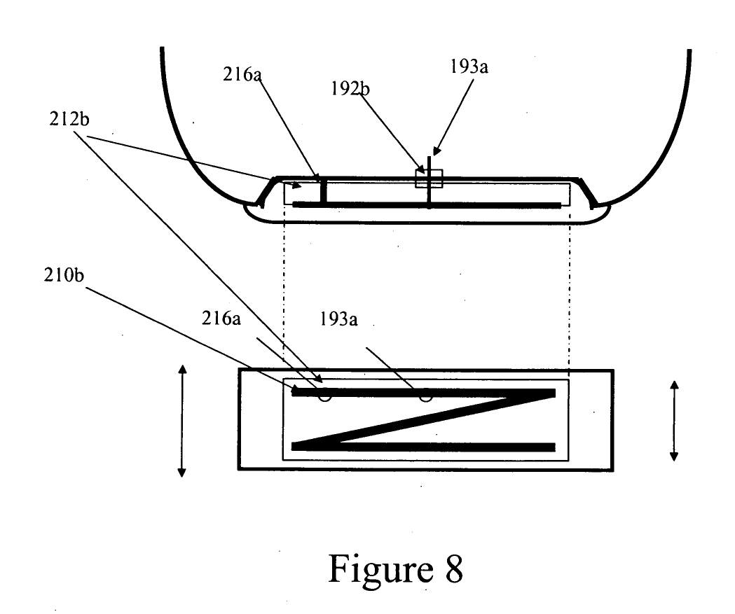

FIG. 8 shows an embodiment wherein an antenna 210b comprises a monopole z-shaped microstrip antenna, approximately 9.3 cm long (⅛^{th} wavelength) and 1 mm wide, disposed on a substrate 212b. In this case, a feed-through 192b has a single wire/pin 193a that attaches to a center section of the antenna 210b. A ground connector 216a attaches to a side portion of the antenna 210b.

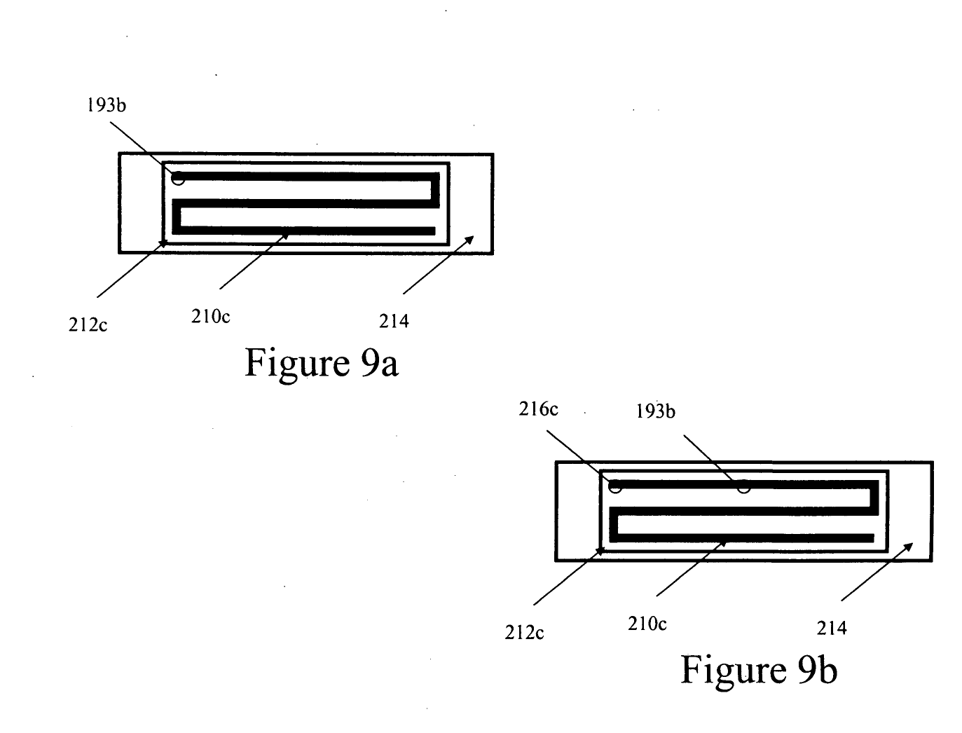

FIG. 9a shows a monopole microstrip serpentine antenna 210c, approximately 9.3 cm long and 1 mm wide, disposed on a substrate 212c, that may be used in the configuration shown in FIG. 8. A single wire/pin (signal feed) 194 corresponds to the like numbered component in FIG. 8.

FIG. 9b shows a modification of the antenna shown in FIG. 9a. In FIG. 9b, the antenna 210c is shown as an inverted-F serpentine antenna by adding a ground feed 216c (connected to the housing) and moving the signal feed 194 to some distance from the ground feed 216c. This type of modification can be done for any other type of monopole antennas shown in the other figures.

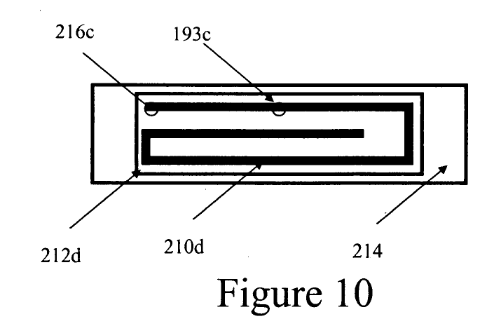

FIG. 10 shows a monopole microstrip spiral antenna 210d, approximately 9.3 cm long and 1 mm wide, disposed on a substrate 212d, that may be used in the configuration shown in FIG. 8. A single wire/pin 193c and a ground connector 216c correspond to the like numbered components in FIG. 8.

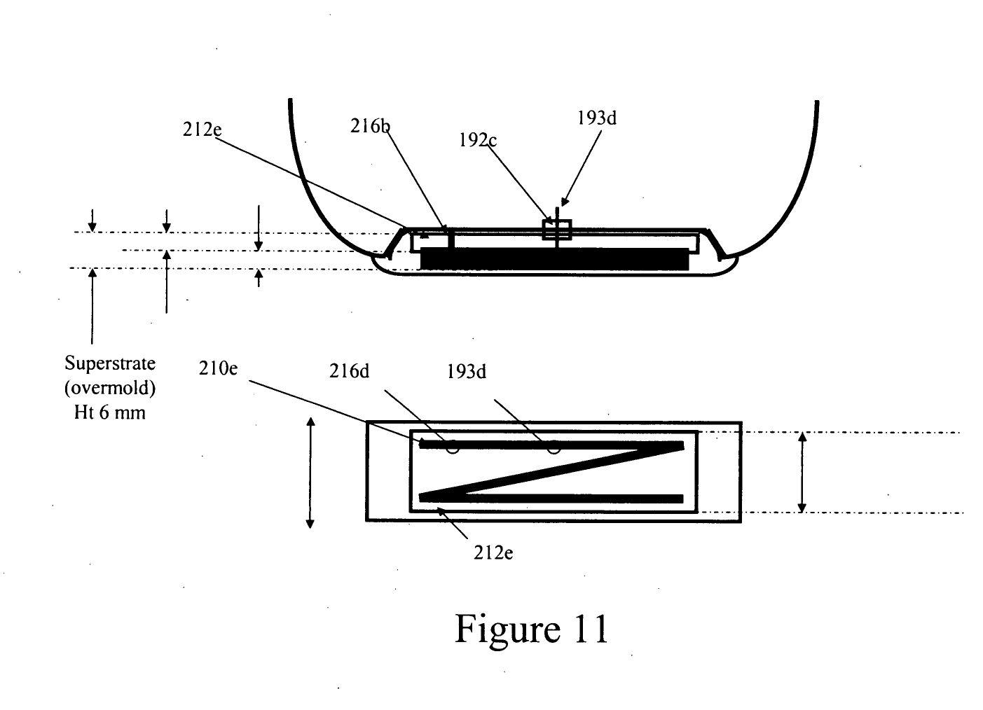

FIG. 11 shows an embodiment wherein an antenna 210e comprises a monopole vertical positioned z-type wafer antenna, approximately 9.3 cm long, 0.5 mm-1 mm wide and 2 mm tall, disposed on a substrate 212e. In this case, a feed-through 192c has a single wire/pin 193d that attaches to a center section of the antenna 210e. A ground connector 216b attaches to a side portion of the antenna 210e.

The vertical antenna 202e can be formed from a reasonably stiff platinum-iridium ribbon/wafer (e.g., thickness of 0.5-1.0 mm) and width of 2.0-3.0 mm, by folding along its width. The antenna 202e will lie on the substrate 212e with its ribbon width in a direction (vertical) that is substantially perpendicular to the plane defined by the substrate 212e. Alternately, the antenna 202e can be made of a single-strand round platinum-iridium wire (e.g., 1-2 mm diameter) of reasonable stiffness so it can be bent and formed into the desired shape. The vertical antenna 202e may be attached to the device 5 according to the attachment process described with reference to FIGS. 6a and 6b.

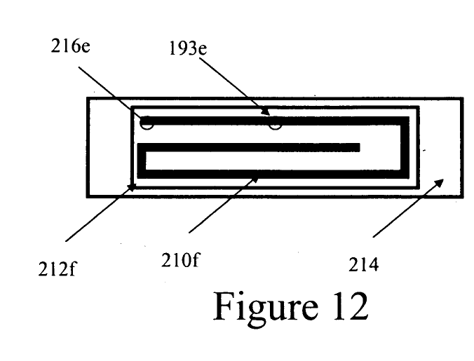

FIG. 12 shows a monopole vertical serpentine wafer antenna 210f, approximately 9.3 cm long, 0.5-1.0 mm thick and 2.0-3.0 mm tall, disposed on a substrate 212f, that may be used in conjunction with the configuration shown in FIG. 11. A single wire/pin 193e and a ground connector 216e correspond to the like numbered components in FIG. 11.

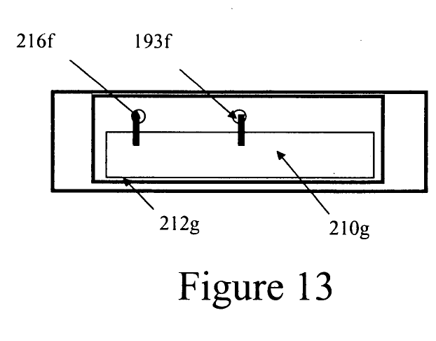

FIG. 13 shows a monopole helical/coiled antenna 210g, disposed on a substrate 212g that may be used in conjunction with the configuration shown in FIG. 11. A single wire/pin 193f without a ground connector 216f corresponds to the like numbered components in FIG. 9a. A single wire/pin 193f and a ground connector 216f correspond to the like numbered components in FIG. 11. The diameter of the enamel-insulated coils of antenna 210g is approximately 0.2-0.5 mm while the length of the antenna (horizontal dimension in the figure) is 18.6-27.8 cm (¼ to ⅜ of wavelength). The enamel-insulated coils can be either tightly wound (i.e. windings touching each other) or loosely wound (i.e. 0.5-1.0 mm gap between adjacent windings).

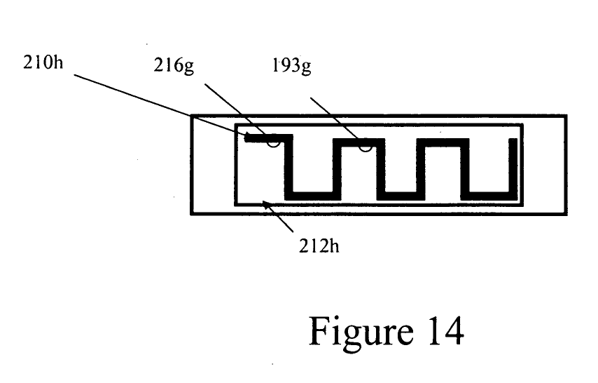

FIG. 14 shows a monopole vertical meandering wafer antenna 210h, disposed on a substrate 212h, that may be used in conjunction with the configuration shown in FIG. 11. A single wire/pin 193g and a ground connector 216g correspond to the like numbered components in FIG. 11.

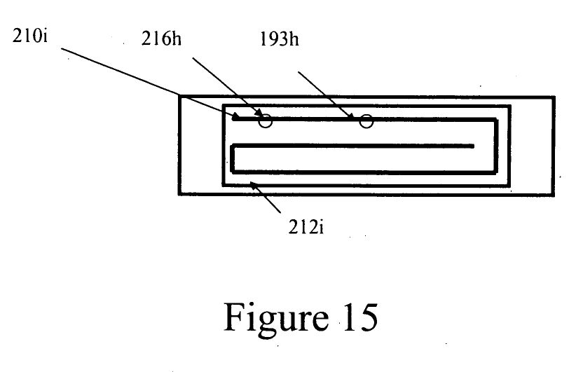

FIG. 15 shows a monopole vertical spiral wafer antenna 210i, disposed on a substrate 212i, that may be used in conjunction with the configuration shown in FIG. 11. A single wire/pin 193h and a ground connector 216h correspond to the like numbered components in FIG. 11.

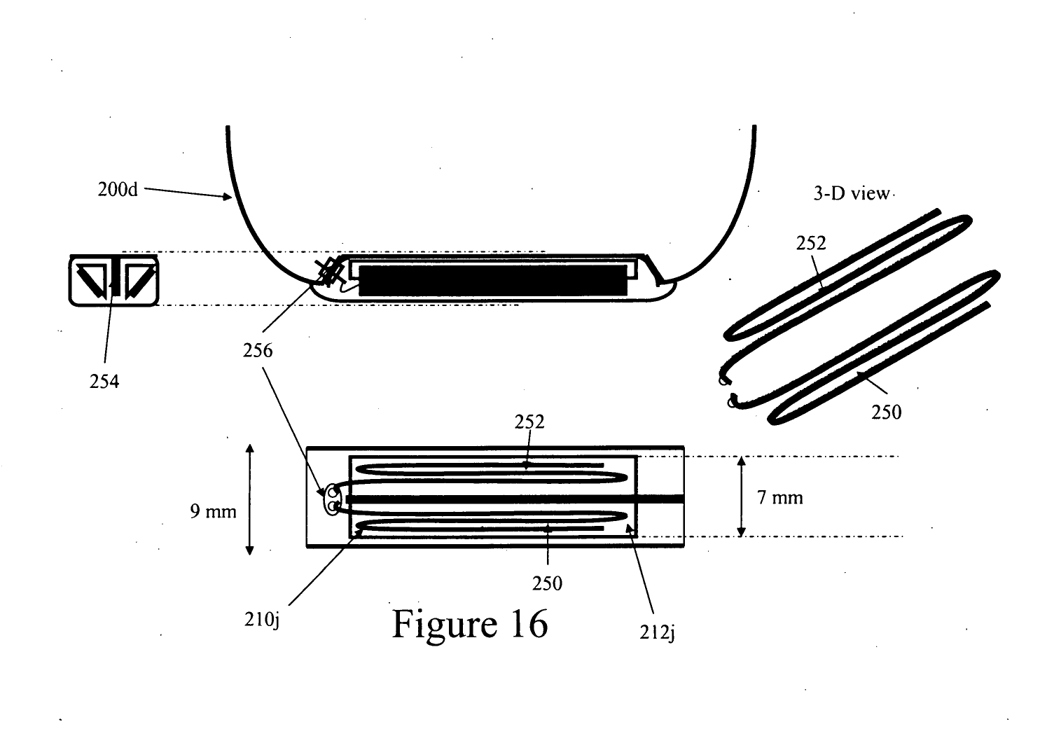

FIG. 16 shows a dipole antenna 210j disposed on a substrate 212j. The dipole antenna 210j comprises two 9.3 cm long portions, each of which is situated so that it is slanted at 45 degrees with respect to a center titanium partition 254. A bipolar feed-through 256 set within a slanted portion of the housing 200d. The antenna 210j is either etched on the substrate 212j (1 mm wide) or comprises a thin wire embedded on the substrate 212j.

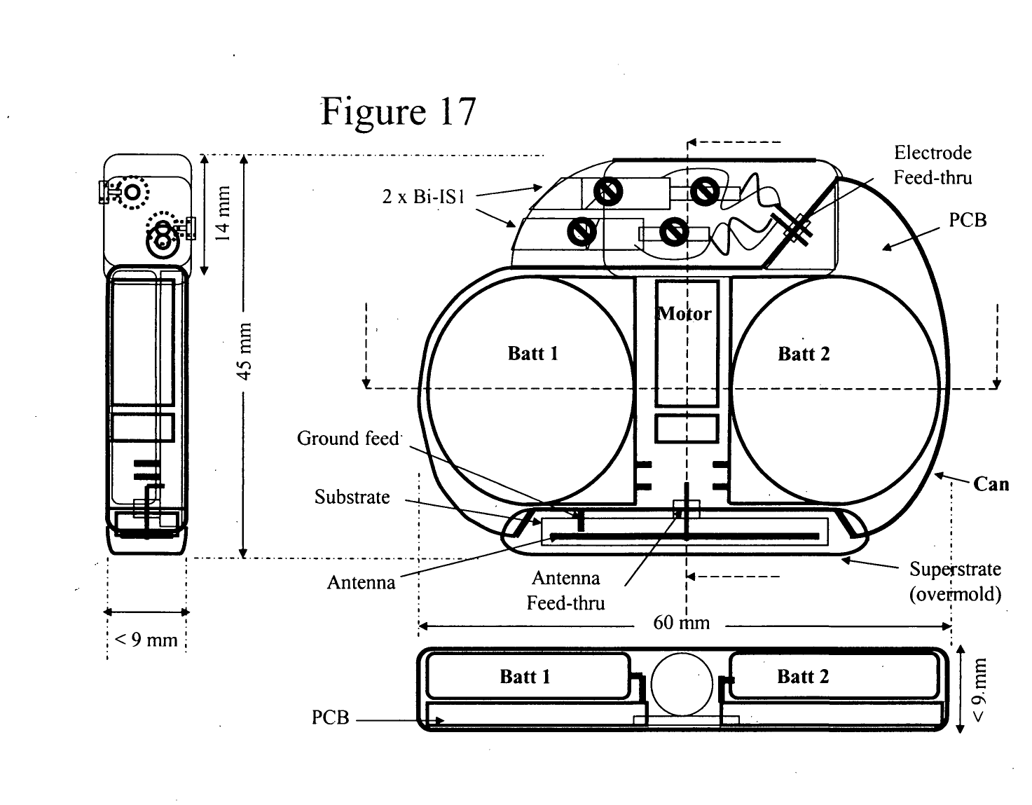

FIG. 17 illustrates a medical device with any of the above mentioned antenna configurations, but with an asymmetrical electrode header profile.

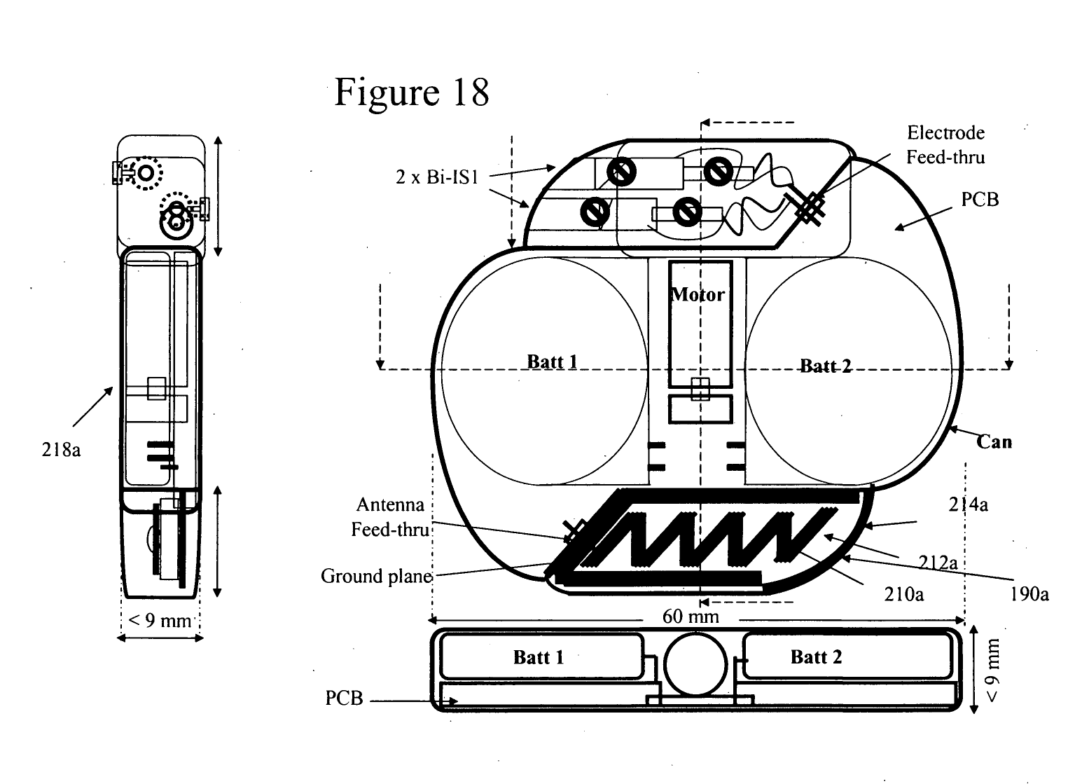

FIG. 18 shows an alternate embodiment in which a footer 190a comprising a substrate 212a that is mounted such that it is substantially parallel to a front side surface 218a. A perimeter side surface 191a has a semi-parallelopiped counter which nests with the footer 190a.

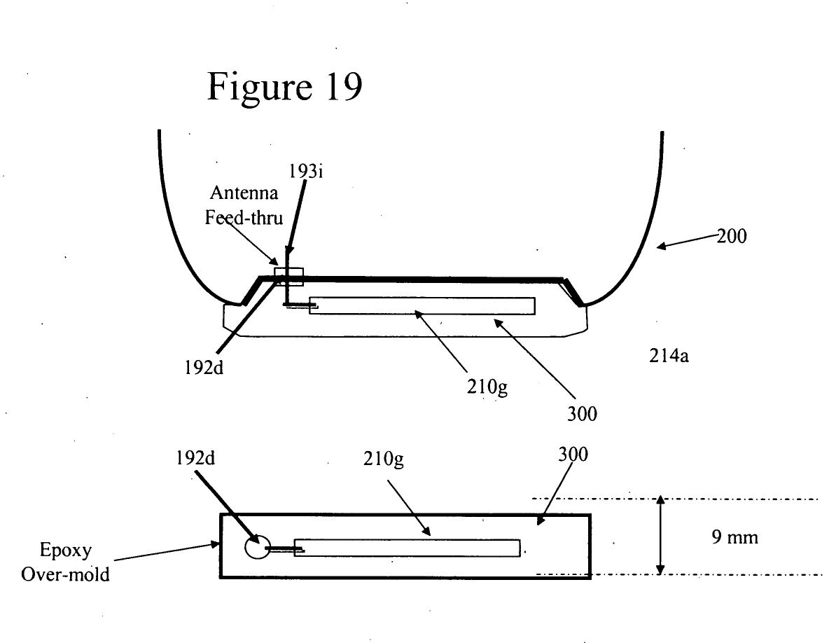

FIG. 19 shows an antenna footer embodiment in which a single insulating layer 214a is molded over a helical antenna 210g to insulate the antenna 210g from the perimeter side of the housing 200 as well as from the body fluids and tissue. During the molding process, an airgap 195d is created around the antenna, so that the insulating material does not flow to the antenna. Typically, the insulation thickness between the perimeter side of the housing 200 and the antenna 210g is 3-4 mm or more, whereas the insulation thickness between the antenna and the body fluids may be less than 3 mm. The antenna 210g is surrounded by a thin layer (1 mm or more on all sides of the antenna) of air gap, over which the insulating layer 214a is molded.

The antenna 210g is electrically coupled to the transceiver (not shown) through a wire/pin 193i that extends through a feed-through 192d. The connection between the wire pin 193i and antenna 210g is maintained through a micro-socket 194d, which is preferably soldered to the antenna 210g before the resulting assembly (antenna 210g and micro-socket 194d) is surrounded by the insulating layer 214a. The molding of the insulating layer 214a is performed in such a way as to avoid covering the opening in the micro-socket 194d. The resulting assembly, which may be called a footer block, is then attached to the enclosure surface 200 by epoxy glue. As a result of the attachment, the micro-socket 194d mates with the feed-through pin 193i.

The micro-socket based attachment procedure may be employed with respect to the header assembly 194. In this case, micro-sockets are attached to lead connectors (e.g. IS-1 connectors), and the resulting sub-assembly is over-molded, thereby creating a header block. The header block is then attached to the housing 200 with epoxy. The micro-sockets mate with the corresponding feed through pins.

1. An antenna assembly adapted for attachment to an implantable device comprising a housing and a transceiver disposed within the housing, the antenna assembly comprising:
a structure adapted for attachment to the housing, the structure formed at least in part from a first type of substance;
a compartment at least partially inside the structure;
an antenna disposed within the compartment; wherein
a second type of substance is disposed within the compartment such that it contacts the antenna.

2. The device of claim 1 wherein the second type of substance fills the space in the compartment not occupied by the antenna.

3. The device of claim 2 wherein the second type of substance is a solid.

4. The device of claim 2 wherein the second type of substance is a gas.

5. The device of claim 1 wherein the structure is premolded.

6. The device of claim 5 wherein the compartment is defined by a cavity within the pre-molded structure.

7. The device of claim 6 wherein the compartment is further defined by a cap disposed on an outer boundary of the structure.

8. The device of claim 5 wherein the compartment is defined by a cavity that is entirely within the interior of the structure.

9. The device of claim 1 wherein the antenna comprises a monopole antenna.

10. The device of claim 1 wherein the antenna comprises a coiled antenna.

11. The device of claim 1 wherein the antenna comprises a micro-strip antenna.

12. The device of claim 1 wherein the antenna is at least partially made of silver.

13. An antenna assembly adapted for attachment to an implantable device comprising a housing and a transceiver disposed within the housing, the antenna assembly comprising:
a compartment adapted for attachment to the housing;
an antenna disposed within the compartment; wherein
the compartment is at least partially filled with a substance characterized by a dielectric constant that is less than 4.5.

14. The device of claim 13 wherein the substance is a gas.

15. The device of claim 14 wherein the gas is air.

16. The device of claim 13 wherein the compartment is a cavity within a pre-molded header that is adapted for attachment to the housing.

17. The device of claim 13 wherein the antenna comprises a coiled antenna.

18. An antenna assembly adapted for attachment to an implantable device comprising a housing and a transceiver disposed within the housing, the antenna assembly comprising:
a header adapted for attachment to the housing, the header having a compartment therein, the header formed mainly from a material characterized by a first dielectric constant;
an antenna disposed within the compartment, the antenna comprising a plurality of coils; and
a substance disposed at least in part between at least two of the plurality of coils, the substance being characterized by a second dielectric constant that is less than the first dielectric constant.

19. The device of claim 18 wherein the substance fills the space in the compartment not occupied by the antenna.

20. The device of claim 19 wherein the substance is a gas.

21. The device of claim 20 wherein the gas is air.

22. An antenna assembly adapted for attachment to an implantable device comprising a housing and a transceiver disposed within the housing, the antenna assembly comprising:
a molded header adapted for attachment to the housing, the header having a cavity therein;
an antenna disposed within the cavity.
